(19) United States
(12) Patent Application Publication
(10) Pub. No.: US 2026/0321898 A1
(43) Pub. Date: Oct. 15, 2026

(54) BATTERY MODULE

(71) Applicant: TOYOTA JIDOSHA KABUSHIKI KAISHA, Toyota-shi (JP)

(72) Inventors: Takayuki SUGIYAMA, Nisshin-shi (JP); Koshiro AONO, Toyota-shi (JP); Yuki TERAZAWA, Toyota-shi (JP)

(21) Appl. No.: 19/464,357

(22) Filed: Jan. 29, 2026

(30) Foreign Application Priority Data
Feb. 14, 2025 (JP) 2025-022789

(51) Int. Cl. H01M 50/503; H01M 50/204; H01M 50/271; H01M 50/507; H01M 50/516; H01M 50/517

(52) U.S. Cl. CPC H01M 50/503; H01M 50/204; H01M 50/271; H01M 50/507; H01M 50/516; H01M 50/517

(57) ABSTRACT

A battery module 10 includes plural battery cells 20 that include electrode terminals 21 and 22, a conductive member 60 that is connected to the electrode terminals 21 and 22 of at least one battery cell 20 of the plural battery cells 20, and a terminal block 50 to which the conductive member 60 is fixed. The conductive member 60 includes a first plate portion 61 having a plate thickness direction in a first direction. The first plate portion 61 is fixed to the terminal block 50. The conductive member 60 includes a second plate portion 62 having a plate thickness direction in a second direction that is a direction perpendicular to the first direction. The second plate portion 62 is fixed to the terminal block 50.

### CROSS-REFERENCE TO RELATED APPLICATION

This application is based on and claims priority under 35 USC 119 from Japanese Patent Application No. 2025-022789, filed on Feb. 14, 2025, the disclosure of which is incorporated by reference herein.

### BACKGROUND

### Technical Field

The present disclosure relates to a battery module.

### Background Art

Patent Document 1 discloses a battery module that includes a battery assembly (plural battery cells) and a bus bar (conductive member) attached to the battery assembly.

### Prior Art Documents

### Patent Documents

Patent Document 1: Japanese Patent Application Laid-Open (JP-A) No. 2023-159718

### SUMMARY

In a battery module such as the one described above, in some cases, a part of the bus bar is fixed to a terminal block and used.

An object of the present disclosure is to facilitate fixing of a part of a bus bar to a terminal block in a battery module.

A battery module according to a first aspect includes: plural battery cells including electrode terminals; a conductive member that is connected to the electrode terminals of at least one battery cell of the plural battery cells; and a terminal block to which the conductive member is fixed, wherein the conductive member includes: a first plate portion that has a thickness direction in a first direction and that is fixed to the terminal block; and a second plate portion that has a thickness direction in a second direction, which is perpendicular to the first direction, and that is fixed to the terminal block.

In the present aspect, a battery module includes plural battery cells that include electrode terminals, a conductive member that is connected to the electrode terminals of at least one battery cell of the plural battery cells, and a terminal block to which the conductive member is fixed.

Furthermore, in the present aspect, the conductive member includes a first plate portion that has a thickness direction in a first direction. The first plate portion is fixed to the terminal block.

Here, the conductive member further includes a second plate portion that has a thickness direction in a second direction that is perpendicular to the first direction. Furthermore, the second plate portion is fixed to the terminal block.

For this reason, by fixing the second plate portion to the terminal block in advance, the conductive member can be positioned with respect to the terminal block, and as a result, the first plate portion can easily be fixed to the terminal block. It should be noted that, since the portion to be previously fixed is the second plate portion, which is different from the first plate portion, it is not necessary to form the first plate portion large, as compared with an aspect in which another portion of the first plate portion is previously fixed.

A battery module according to a second aspect is the battery module according to the first aspect, wherein: the second plate portion has a second through hole that penetrates the second plate portion; the terminal block includes a terminal block main body, a nut that is held by the terminal block main body, and a fixing pin that protrudes from the terminal block main body in the second direction; the first plate portion is fixed to the terminal block by fastening the first plate portion together with another conductive member, using the nut; and the second plate portion is fixed to the terminal block by inserting the fixing pin into the second through hole of the second plate portion.

In the present aspect, the terminal block includes a terminal block main body and a nut that is held by the terminal block main body. The first plate portion is fixed to the terminal block by fastening the first plate portion together with another conductive member, using the nut.

As a result, since the position of the first plate portion with respect to the terminal block can be determined by fixing the second plate portion to the terminal block in advance, the aforementioned operation of mutual fastening can be facilitated.

Furthermore, in the present aspect, the second plate portion has a second through hole that penetrates the second plate portion, and the terminal block includes a fixing pin that protrudes from the terminal block main body in the second direction. The second plate portion is fixed to the terminal block by inserting the fixing pin into the second through hole of the second plate portion.

For this reason, positioning in the first direction and the third direction can be performed by fixing the second plate portion to the terminal block. Note that the third direction means a direction perpendicular to both the first direction and the second direction.

A battery module according to a third aspect is the battery module according to the first aspect or the second aspect, wherein: the conductive member includes a first plate and a second plate having a plate thickness that is smaller than a plate thickness of the first plate; and the second plate is welded to the electrode terminals of the battery cell.

In the present aspect, the conductive member includes a first plate and a second having a plate thickness that is smaller than a plate thickness of the first plate.

As a result, both current-carrying performance and strength reliability can be achieved. This is because strength reliability can be ensured by the second plate having a relatively small plate thickness, and current-carrying performance can be ensured by the first plate having a relatively large plate thickness.

Note that the plate thickness referred to here means an average plate thickness.

Furthermore, in the present aspect, the second plate is welded to the electrode terminals of the battery cell.

As a result, since the second plate having a relatively small plate thickness can be welded (for example, laser welded), a welding operation can be facilitated.

A battery module according to a fourth aspect is the battery module according to the third aspect, wherein the second plate includes: a third plate portion that is joined to the first plate; a fourth plate portion that is welded to the electrode terminals; and a displacement absorbing portion that connects the third plate portion and the fourth plate portion and that facilitates relative displacement of the third plate portion and the fourth plate portion.

In the present aspect, the second plate includes a third plate portion that is joined to the first plate, a fourth plate portion that is connected to the electrode terminals, and a displacement absorbing portion that connects the third plate portion and the fourth plate portion and that facilitates relative displacement of the third plate portion and the fourth plate portion.

Therefore, positional deviation between the electrode terminals and the terminal block can be absorbed by the displacement absorbing portion of the conductive member. Furthermore, since the displacement absorbing portion is formed in the second plate, which has a relatively small plate thickness, performance of the displacement absorbing portion can easily be ensured.

A battery module according to a fifth aspect is the battery module according to any one of the first aspect to the fourth aspect, wherein: the battery module includes a cover member that covers the second plate portion; and the cover member includes a locked portion that is locked to the terminal block so as to determine a position, in the second direction, of the cover member with respect to the terminal block.

In the present aspect, the battery module includes a cover member that covers the second plate portion.

Here, the cover member includes a locked portion that is locked to the terminal block so as to determine a position, in the second direction, of the cover member with respect to the terminal block.

For this reason, the position of the conductive member, in the second direction, with respect to the terminal block is determined via the cover member.

According to the present disclosure, in a battery module, a part of a bus bar can easily be fixed to a terminal block.

### BRIEF DESCRIPTION OF THE DRAWINGS

FIG. 1 schematically illustrates an exploded view of a battery module 10.

FIG. 2 is a schematic diagram of a battery 90 that includes plural battery modules 10.

FIG. 3 is a perspective view of an end bus bar (conductive member).

FIG. 4 is a schematic cross-sectional view illustrating a relationship between a terminal block and an end bus bar (conductive member).

FIG. 5 is a schematic cross-sectional view illustrating a relationship between a cover and a terminal block.

### DETAILED DESCRIPTION

Explanation follows regarding a preferred embodiment of the present disclosure.

Note that in each of the drawings, as appropriate, the arrow FR indicates the front of a vehicle, the arrow UP indicates an upper part of a vehicle, and the arrow LH indicates the left side in a vehicle width direction. Furthermore, in the following explanation, in cases in which front-rear, up-down, and left-right directions are described without any particular notation to the contrary, these indicate front and rear in a vehicle front-rear direction, up and down in a vehicle up-down direction, and left and right in the vehicle width direction, respectively.

Moreover, three directions perpendicular to each other will be described as a "first direction", a "second direction", and a "third direction". In the following exemplary embodiment, although the first direction is the vehicle up-down direction, the second direction is the vehicle width direction, and the third direction is the vehicle front-rear direction, the "first direction", the "second direction", and the "third direction" of the present disclosure are not limited thereto.

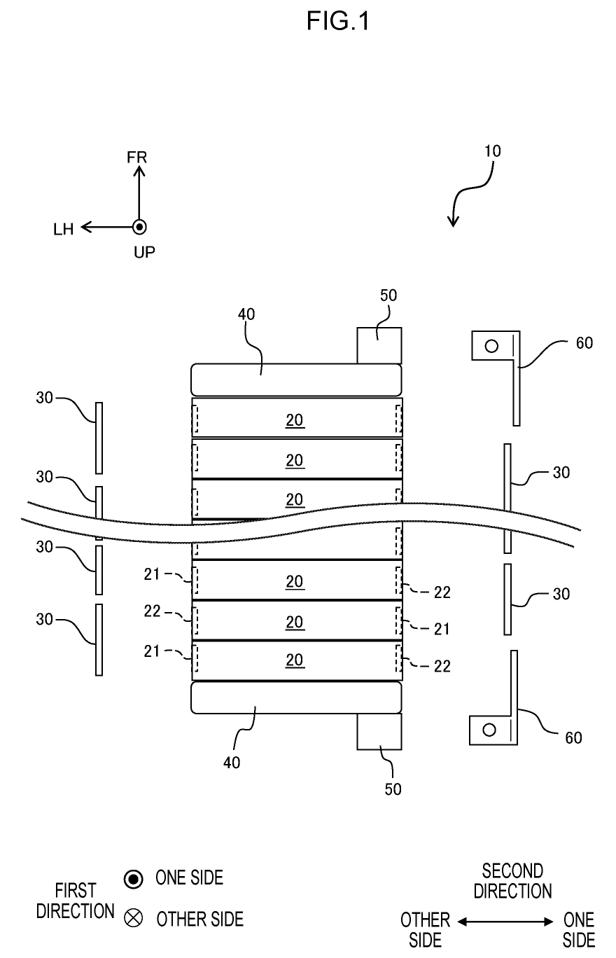

FIG. 1 schematically illustrates an exploded view of a battery module 10 of the present exemplary embodiment.

The battery module 10 includes plural battery cells 20, plural inter-cell connection bus bars 30, a pair of end plates 40, a terminal block 50 fixed to each of the pair of end plates 40, and a pair of end bus bars 60 respectively fixed to each of the terminal blocks 50.

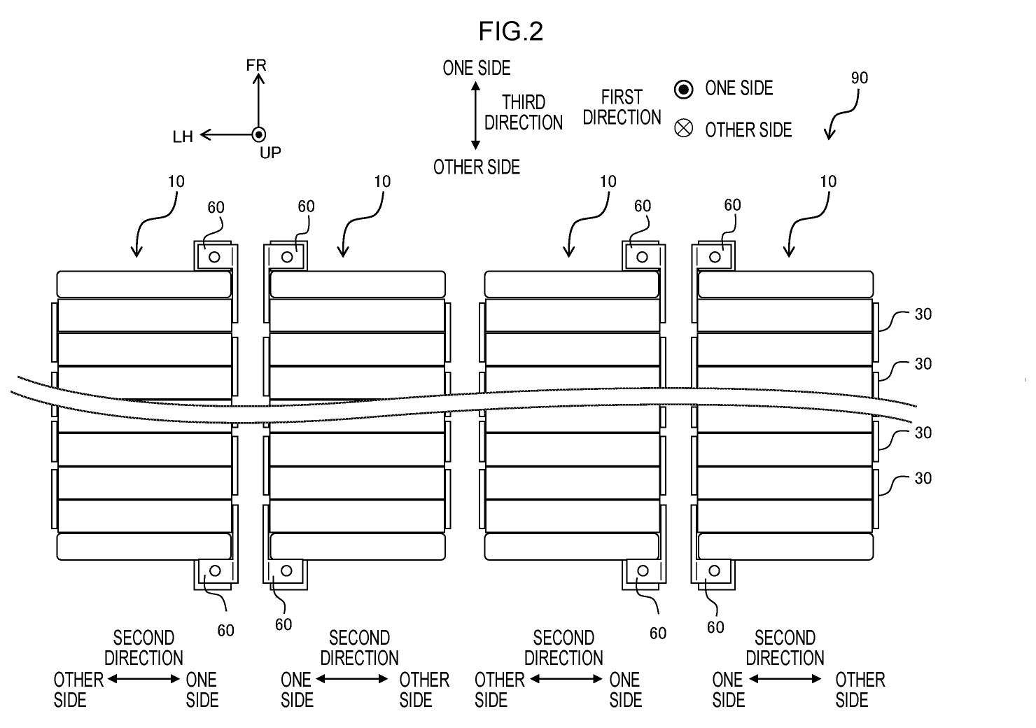

FIG. 2 illustrates a battery 90 that includes plural battery modules 10.

In the battery 90, the plural battery modules 10 are arranged along the second direction. Two battery modules 10 adjacent in the second direction are connected to each other (not illustrated in the drawings) using respective end bus bars 60 at a third direction one side. The end bus bars 60 at the third direction one side are connected to, for example, a junction block via a bus bar not illustrated in the drawings.

The battery cell 20 is a rectangular cell. A thickness direction of the battery cell 20 is the third direction. In other words, a third direction dimension of the battery cell 20 is smaller than both a first direction dimension and a second direction dimension. Plural battery cells 20 are arranged along the third direction.

The battery cell 20 includes electrode terminals 21 and 22. Specifically, the battery cell 20 includes a positive electrode terminal 21 and a negative electrode terminal 22. The positive electrode terminal 21 and the negative electrode terminal 22 are respectively provided at both side surfaces, in the second direction, of the battery cell 20.

The inter-cell connection bus bar 30 connects two adjacent battery cells 20 to each other in an arrangement direction (the third direction).

The pair of end plates 40 are provided so as to sandwich the plural battery cells 20 in the arrangement direction thereof. The pair of end plates 40 are connected to each other by a restraining member (not illustrated in the drawings). The end plate 40 is, for example, an aluminum die-cast product.

A pair of terminal blocks 50 are respectively provided at an outer side in the third direction with respect to the pair of end plates 40.

The pair of end bus bars 60 are fixed to the pair of terminal blocks 50. Hereinafter, the end bus bar 60 may be referred to as a conductive member 60.

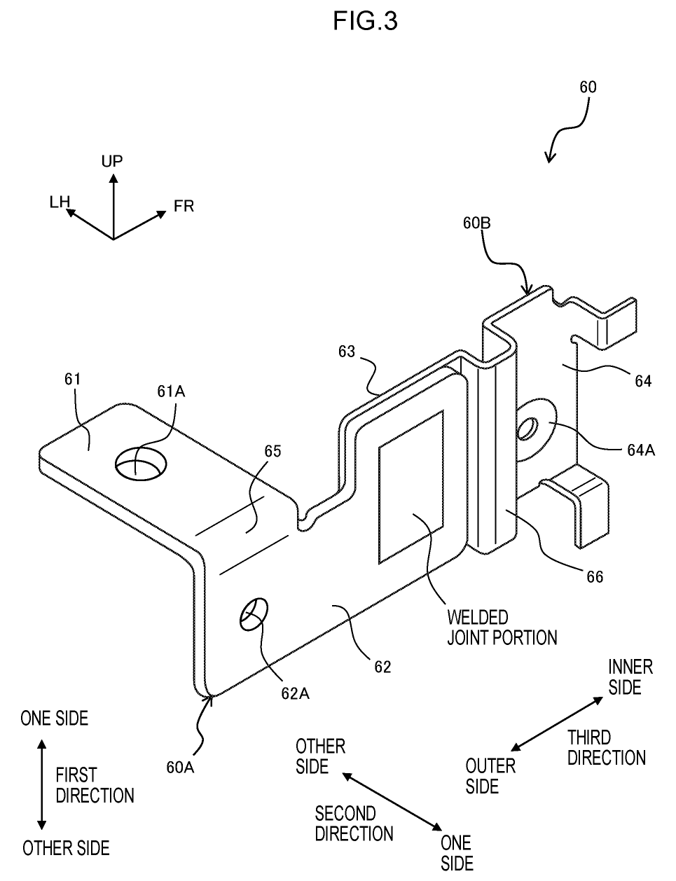

As illustrated in FIG. 3, the conductive member 60 includes a first plate 60A and a second plate 60B. The second plate 60B is formed of a plate material having a plate thickness that is smaller than a plate thickness of the first plate 60A. The second plate 60B is joined to the first plate 60A so as to be integrated with the first plate 60A, thereby forming the conductive member 60. The first plate 60A and the second plate 60B are formed of aluminum.

The first plate 60A includes a first plate portion 61 having a plate thickness direction in the first direction, a second plate portion 62 having a plate thickness direction in the second direction, and a first bent portion 65 that connects the first plate portion 61 and the second plate portion 62.

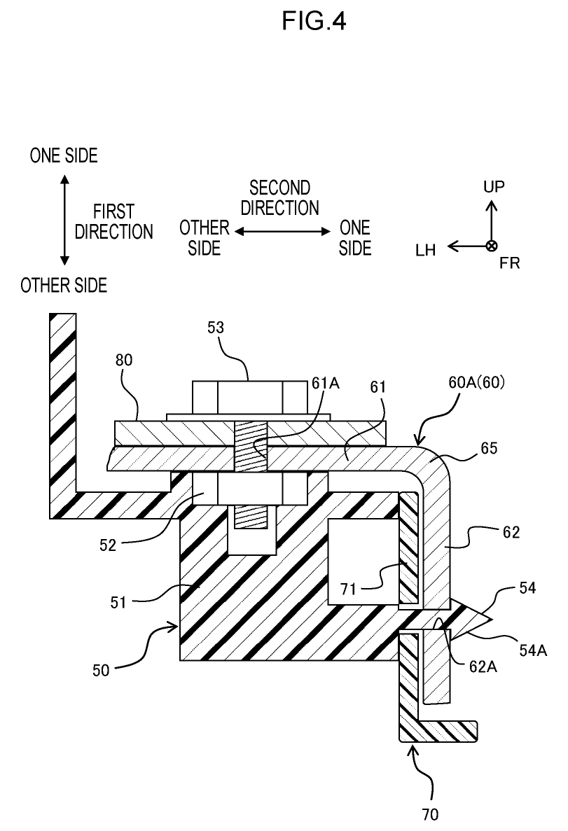

The first plate portion 61 has a first through hole 61A that penetrates the first plate portion 61. As illustrated in FIG. 4, the first plate portion 61 is fixed to the terminal block 50 using the first through hole 61A.

The second plate portion 62 is provided further toward a second direction one side than the first plate portion 61. The first bent portion 65 is a bent portion that extends in the third direction.

The second plate portion 62 has a second through hole 62A that penetrates the second plate portion 62. The second plate portion 62 is fixed to the terminal block 50 using the second through hole 62A. The second through hole 62A is provided at a position that overlaps with the first plate portion 61 in the third direction. Specifically, the second through hole 62A is a hole that is smaller than the first through hole 61A and is provided at a position that overlaps with the first through hole 61A in the third direction.

The second plate portion 62 is joined to the second plate 60B at a part closer to an inner side in the third direction than a part overlapping with the first plate portion 61 in the third direction. The part of the second plate portion 62 that is joined to the second plate 60B has a greater dimension in the first direction than the part of the second plate portion 62 which overlaps with the first plate portion 61 in the third direction.

An end, at a first direction one side, of the part of the second plate portion 62 that is joined to the second plate 60B is positioned further toward the first direction one side than the first bent portion 65.

An end, at a first direction other side, of the part of the second plate portion 62 that is joined to the second plate 60B is coincident with a position, in the first direction, of an end, at the first direction other side of the part of the second plate portion 62 which overlaps with the first plate portion 61 in the third direction.

The second plate 60B includes a third plate portion 63 having a plate thickness direction in the second direction, a fourth plate portion 64 having a plate thickness direction in the second direction, and a displacement absorbing portion 66 that connects the third plate portion 63 and the fourth plate portion 64 and that facilitates relative displacement of the third plate portion 63 and the fourth plate portion 64.

The third plate portion 63 is welded in a state of being overlapped, in the plate thickness direction, with part of the second plate portion 62. The welding method is, specifically, laser welding. The third plate portion 63 is arranged further toward a second direction other side than the second plate portion 62.

The fourth plate portion 64 is welded to the electrode terminals 21 and 22 of the battery cell 20. The welding method is, specifically, laser welding. The fourth plate portion 64 is arranged further toward the second direction one side than the electrode terminals 21 and 22. The fourth plate portion 64 includes a part to be welded 64A, which has been partially thinned in thickness in order to facilitate laser welding.

The displacement absorbing portion 66 is formed by combining bent parts extending in the first direction. The displacement absorbing portion 66 mainly absorbs relative displacement in the second direction and the third direction, but can also absorb relative displacement in the first direction. By providing the displacement absorbing portion 66, it is possible to suppress positional deviation of the first plate portion 61 and the like, even in a case in which the position of the fourth plate portion 64, which is connected to the electrode terminals 21 and 22, is displaced.

As illustrated in FIG. 4, the terminal block 50 includes a terminal block main body 51 that is formed of a synthetic resin, and a nut 52 that is held by the terminal block main body 51.

The nut 52 is insert-molded into the terminal block main body 51. In other words, the terminal block main body 51 is insert-molded with the nut 52 as an insert part.

The first plate portion 61 is fixed to the terminal block 50 by fastening the first plate portion 61 together with another conductive member 80, using the nut 52. Specifically, a first bolt 53 is passed through a through hole of the other conductive member 80 and the first through hole 61A, and is screwed into the nut 52. The first bolt 53 is screwed from the first direction one side.

The terminal block 50 includes a fixing pin 54 that protrudes from the terminal block main body 51 in the second direction. The fixing pin 54 is integrally molded with the terminal block main body 51. The second plate portion 62 is fixed to the terminal block 50 by inserting the fixing pin 54 into the second through hole 62A of the second plate portion 62. The fixing pin 54 has a slip-off prevention portion 54A at a tip thereof.

Furthermore, the battery module 10 includes a cover member 70 that covers at least the second plate portion 62.

The cover member 70 includes a portion 71 that is arranged at the second direction other side with respect to the second plate portion 62 of the conductive member 60. Note that the cover member 70 may include a portion (not illustrated in the drawings) arranged at the second direction one side with respect to the second plate portion 62.

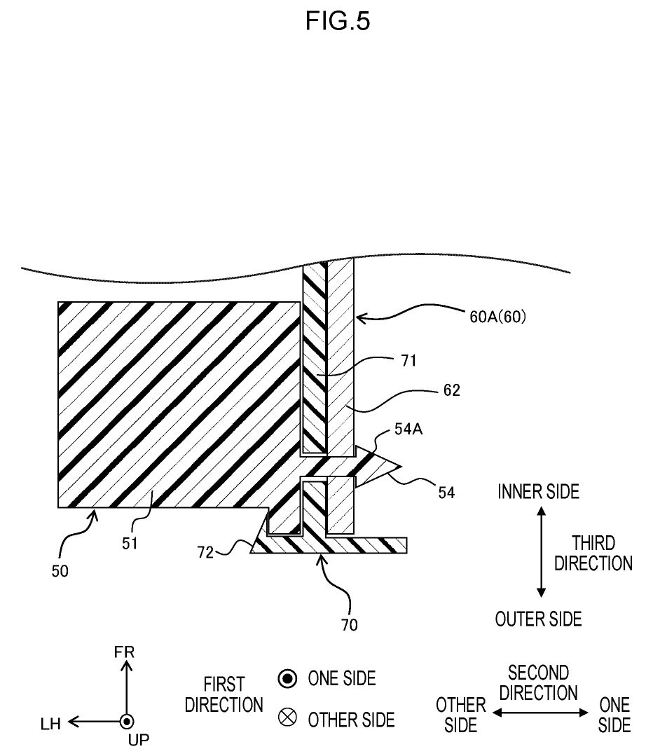

As illustrated in FIG. 5, the cover member 70 includes a locked part 72 that is locked to the terminal block 50. The locked part 72 functions to determine the position of the cover member 70, in the second direction, with respect to the terminal block 50. The locked portion 72 is provided further toward a third direction outer side than the second plate portion 62. The locked portion 72 is provided further toward the first direction other side than the first plate portion 61.

### Operation and Effects

Next, explanation follows regarding operations and effects of the present exemplary embodiment.

In the present exemplary embodiment, as illustrated in FIG. 1, the battery module 10 includes plural battery cells 20 that include the electrode terminals 21 and 22, the conductive member 60 that is connected to the electrode terminals 21 and 22 of at least one battery cell 20 of the plural battery cells 20, and the terminal block 50 to which the conductive member 60 is fixed.

Furthermore, in the present exemplary embodiment, as illustrated in FIGS. 3 and 4, the conductive member 60 includes the first plate portion 61 having a thickness direction in the first direction. The first plate portion 61 is fixed to the terminal block 50.

Here, the conductive member 60 further includes the second plate portion 62 having a plate thickness direction in the second direction that is a direction perpendicular to the first direction. The second plate portion 62 is fixed to the terminal block 50.

For this reason, by fixing the second plate portion 62 to the terminal block 50 in advance, the conductive member 60 can be positioned with respect to the terminal block 50, and as a result, the first plate portion 61 can easily be fixed to the terminal block 50. It should be noted that, since the portion to be previously fixed is the second plate portion 62, which is different from the first plate portion 61, it is not necessary to form the first plate portion 61 large, as compared with an aspect in which another portion of the first plate portion 61 is previously fixed.

Furthermore, in the present exemplary embodiment, as illustrated in FIG. 4, the terminal block 50 includes the terminal block main body 51 and the nut 52 that is held by the terminal block main body 51. The first plate portion 61 is fixed to the terminal block 50 by fastening the first plate portion 61 together with the other conductive member 80, using the nut 52.

As a result, since the position of the first plate portion 61 with respect to the terminal block 50 can be determined by fixing the second plate portion 62 to the terminal block 50 in advance, the aforementioned operation of mutual fastening can be facilitated.

Furthermore, in the present exemplary embodiment, as illustrated in FIG. 4, the second plate portion 62 includes the second through hole 62A that penetrates the second plate portion 62, and the terminal block 50 includes the fixing pin 54 that protrudes from the terminal block main body 51 in the second direction. The second plate portion 62 is fixed to the terminal block 50 by inserting the fixing pin 54 into the second through hole 62A of the second plate portion 62.

For this reason, positioning in the first direction and the third direction can be performed by fixing the second plate portion 62 to the terminal block 50.

Furthermore, in the present exemplary embodiment, as illustrated in FIG. 3, the conductive member 60 includes the first plate 60A and the second plate 60B that has a smaller plate thickness than the plate thickness of the first plate 60A.

As a result, both current-carrying performance and strength reliability can be achieved. This is because strength reliability can be ensured by the second plate 60B having a relatively small plate thickness, and current-carrying performance can be ensured by the first plate 60A having a relatively large plate thickness. Note that the plate thickness referred to here means an average plate thickness.

Furthermore, in the present exemplary embodiment, the second plate 60B is welded to the electrode terminals 21 and 22 of the battery cell 20.

As a result, since the second plate 60B having a relatively small plate thickness can be welded (for example, laser welded), the welding operation can be facilitated.

Furthermore, in the present exemplary embodiment, as illustrated in FIG. 3, the second plate 60B includes the third plate portion 63 that is joined to the first plate 60A, the fourth plate portion 64 that is connected to the electrode terminals 21 and 22, and the displacement absorbing portion 66 that connects the third plate portion 63 and the fourth plate portion 64 and that facilitates relative displacement of the third plate portion 63 and the fourth plate portion 64.

Therefore, positional deviation between the electrode terminals 21 and 22 and the terminal block 50 can be absorbed by the displacement absorbing portion 66 of the conductive member 60. Furthermore, since the displacement absorbing portion 66 is formed in the second plate 60B, which has a relatively small plate thickness, performance of the displacement absorbing portion 66 can easily be ensured.

Furthermore, in the present exemplary embodiment, as illustrated in FIG. 5, the battery module 10 includes the cover member 70 that covers the second plate portion 62.

Here, the cover member 70 includes the locked part 72 that is locked to the terminal block 50 so as to determine the position of the cover member 70, in the second direction, with respect to the terminal block 50.

Therefore, the position of the conductive member 60, in the second direction, with respect to the terminal block 50 is determined via the cover member 70.

Furthermore, in the present exemplary embodiment, as illustrated in FIG. 2, the first direction is the vehicle up-down direction. As a result, for example, the first plate portion 61 can be fixed to the terminal block 50 from the upper side of the vehicle, whereby the fixing operation is easy.

While a preferred embodiment of the present disclosure has been described above, the present disclosure is not limited to the above description.

### EXPLANATION OF REFERENCE NUMERALS

10 battery module

20 battery cell

21 positive electrode terminal (electrode terminal)

22 negative electrode terminal (electrode terminal)

50 terminal block

52 nut

54 fixing pin

60 end bus bar (conductive member)

60A first plate

60B second plate

61 first plate portion

61A first through hole

62 second plate portion

62A second through hole

63 third plate portion

64 fourth plate portion

66 displacement absorbing portion

70 cover member

72 locked portion

What is claimed is:

1. A battery module, comprising:
a plurality of battery cells including electrode terminals;
a conductive member that is connected to the electrode terminals of at least one battery cell of the plurality of battery cells; and
a terminal block to which the conductive member is fixed,
wherein the conductive member comprises:
a first plate portion that has a thickness direction in a first direction and that is fixed to the terminal block; and
a second plate portion that has a thickness direction in a second direction, which is perpendicular to the first direction, and that is fixed to the terminal block.

2. The battery module according to claim 1, wherein:
the second plate portion has a second through hole that penetrates the second plate portion;
the terminal block comprises a terminal block main body, a nut that is held by the terminal block main body, and a fixing pin that protrudes from the terminal block main body in the second direction;
the first plate portion is fixed to the terminal block by fastening the first plate portion together with another conductive member, using the nut; and
the second plate portion is fixed to the terminal block by inserting the fixing pin into the second through hole of the second plate portion.

3. The battery module according to claim 1, wherein:
the conductive member comprises a first plate and a second plate having a plate thickness that is smaller than a plate thickness of the first plate; and
the second plate is welded to the electrode terminals of the battery cell.

4. The battery module according to claim 3, wherein the second plate comprises:
a third plate portion that is joined to the first plate;
a fourth plate portion that is welded to the electrode terminals; and
a displacement absorbing portion that connects the third plate portion and the fourth plate portion and that facilitates relative displacement of the third plate portion and the fourth plate portion.

5. The battery module according to claim 1, wherein:
the battery module comprises a cover member that covers the second plate portion; and
the cover member comprises a locked portion that is locked to the terminal block so as to determine a position, in the second direction, of the cover member with respect to the terminal block.
